(19) United States
(12) Patent Application Publication
(10) Pub. No.: US 2009/0015517 A1
(43) Pub. Date: Jan. 15, 2009

(54) Plasma display panel

(76) Inventor: Jung-tae Park, Suwon-si (KR)

Correspondence Address: ROBERT E. BUSHNELL, 1522 K STREET NW, SUITE 300, WASHINGTON, DC, 20005-1202, US

(21) Appl. No.: 12/073,453

(22) Filed: Mar. 5, 2008

(30) Foreign Application Priority Data
Jul. 10, 2007 (KR) 10-2007-0069138

(51) Int. Cl. G09G 3/28

(52) U.S. Cl. 345/60

(57) ABSTRACT

A plasma display panel. The plasma display panel is constructed with a dielectric layer covering a sustain electrode of a front substrate. The thickness of the dielectric layer is defined in a certain thickness range to improve a discharge firing voltage and a luminance saturation rate of a phosphor.

### CLAIM OF PRIORITY

This application makes reference to, incorporates the same herein, and claims all benefits accruing under 35 U.S.C. § 119 from an application earlier filed in the Korean Intellectual Property Office on 10 Jul. 2007 and there duly assigned Serial No. 10-2007-0069138.

### BACKGROUND OF THE INVENTION

1. Field of the Invention

The present invention relates to a display device using a plasma display panel, wherein the display device is referred to as a display device that display an image by injecting a discharge gas in a discharge cell divided into a front substrate and a rear substrate by a barrier rib between them, sealing the discharge cell, applying a discharge voltage to the discharge cell to generate a vacuum ultraviolet ray from discharge gases, and allowing a phosphor in the discharge cell to emit the light using the vacuum ultraviolet rays.

2. Description of the Related Art

A period for controlling a plasma display panel is divided into a reset period for resetting all discharge cells formed inside the plasma display panel, an address period for selecting discharge cells to be discharged, a sustain period for sustaining discharge of the selected cells, and a blanking period for eliminating a wall charge in the discharged cells.

A general example of a driving waveform of this plasma display panel is disclosed in Korean Patent Publication No. 10-2006-0065381. Referring to the patent, problems of the contemporary plasma display panel will be described briefly.

First, a sustain pulse is alternatively applied to a Y electrode and an X electrode that constitute a sustain electrode during a sustain period. A sustain discharge is generated between the Y electrode and the X electrode in the cells selected by an address discharge whenever every sustain pulse is applied to the corresponding Y and X electrodes while a wall voltage and a sustain pulse is increasingly applied to the selected cells.

Meanwhile, an intensity of the light generated by a phosphor layer of the plasma display panel does not increase with an increasing number of the sustain pulses; instead, the phosphor has a luminance saturation property where the phosphor is saturated at a certain luminance point, that is, a point where luminance of a phosphor is saturated.

Assume that a luminance point is a point where the number of sustain pulses is 300. Then, the intensity of the light generated by the corresponding phosphor is as much as the intensity of the light generated at a point where the number of sustain pulses is 300, even if 500 sustain pulses are applied to the phosphor. This luminance saturation of the phosphor occurs when a sustain pulse is continuously applied to the phosphor.

Considering the cause of luminance saturation property of the phosphor, a phosphor is present in discharge cells under a stable state at an early stage. When the phosphor is relatively unstable after the sustain discharge, the phosphor emits a certain amount of light. Then after a certain time period, the phosphor returns to a stable state.

That is, the phosphor is in an unstable state if a sustain discharge appears, and then returns to the stable state with a passage of a certain time. If a sustain pulse is continuously applied to the phosphor having this physical property, the continuous sustain discharge is generated, and then the phosphor becomes unstable again due to the presence of the sustain discharge before the phosphor returns to a stable state. Luminance of the phosphor is saturated by continuously keeping the phosphor unstable due to the repeated presence of the sustain discharge.

As a result, a luminance of the plasma display panel is lowered and the driving efficiency of the plasma display panel is reduced because the increase in sustain pulse does not lead to the increase in the light intensity resulted from the luminance saturation properties of the phosphor. In addition, the luminance saturation property of the phosphor is related to a problem regarding the increase of discharge firing voltage in the high-resolution plasma display panel, and therefore there have been attempts to solve the above problems.

### SUMMARY OF THE INVENTION

It is therefore one object of the present invention to provide an improved plasma display panel and an improved method for driving the plasma display panel.

It is another object of the present invention to solve the drawbacks of the prior art by providing3 a display device using a plasma display panel.

According to one aspect of the present invention, a plasma display panel may be constructed with a front panel including a sustain electrode, a rear panel including an address electrode extending in a direction crossing the sustain electrode, and a discharge space formed between the front panel and the rear panel. The front panel may be constructed with a front substrate, and a dielectric layer burying the sustain electrode. The dielectric layer may have a thickness of approximately 28 μm to approximately 37 μm.

The dielectric layer is preferably having a thickness of approximately 30 μm to approximately 37 μm.

The dielectric layer may be made from one selected from the group consisting essentially of PbO, B₂O₃, and SiO₂.

Discharge gases may be filled in the discharge space. The discharge gases may include Xe.

The Xe in the discharge gases may have a partial pressure of approximately 8 to approximately 15%.

According to another aspect of the present invention, a plasma display panel may be constructed with a front panel, a rear panel facing the front panel, a barrier rib formed between the front panel and the rear panel and dividing a discharge space containing discharge gases into certain patterns, and a phosphor layer provided inside the discharge space. The front panel may be constructed with a front substrate, a sustain electrode formed on a first surface of the front substrate, a first dielectric layer burying the sustain electrode, and a protective layer protecting the first dielectric layer. The rear panel may be constructed with an address electrode and a second dielectric layer burying the address electrode. The address electrode and the second dielectric layer are formed on a surface of the rear panel facing the front substrate. The first dielectric layer may have a thickness of approximately 28 μm to approximately 37 μm.

The sustain electrode may include a Y electrode for selecting a discharge cell with the address electrode, and an X electrode for generating a sustain discharge in the selected discharge cell with the Y electrode.

The first dielectric layer is preferably having a thickness of approximately 30 μm to approximately 37 μm.

The dielectric layer may be made from one selected from the group consisting essentially of PbO, B₂O₃, and SiO₂.

The discharge gases presented in the discharge space may include Xe.

The Xe in the discharge gases may have a partial pressure of approximately 8% to approximately 15%.

According to still another aspect of the present invention, a method for driving a plasma display panel may be provided. The plasma display panel may be constructed with a first dielectric layer burying the sustain electrode, and an address electrode buried by a second dielectric layer. The first dielectric layer may have a thickness of 28 to 37 μm. The method for driving the plasma display panel includes applying a sustain pulse to a sustain electrode formed in the plasma display panel. The frequency of the sustain pulse may range from approximately 200 KHz to approximately 300 KHz.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a waveform view showing a sustain drive mode of a contemporary plasma display panel;

FIG. 2 is a graph showing a luminance saturation rate of the phosphor in the contemporary plasma display panel;

FIG. 3 is an oblique view showing a plasma display panel constructed as one embodiment according to the principles of the present invention;

FIG. 4 is a graph illustrating luminance saturation property of a phosphor layer constructed with a dielectric layer having various thickness according to one embodiment of the present invention; and

FIG. 5 is a graph illustrating a luminance property of a plasma display panel constructed with a dielectric layer having various thickness, versus Xe content according to one embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

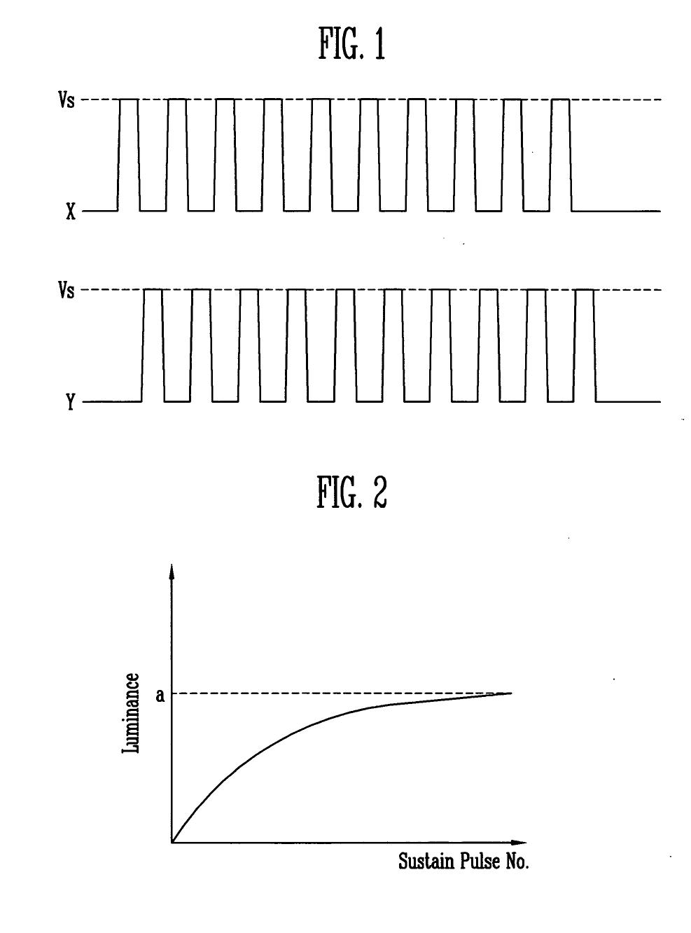

First, FIG. 1 is a waveform view showing a sustain drive mode of a contemporary plasma display panel. Referring to FIG. 1, a sustain pulse Vs is alternatively applied to a Y electrode and an X electrode that constitute a sustain electrode during a sustain period. A sustain discharge is generated between the Y electrode and the X electrode in the discharge cells selected by an address discharge whenever a sustain pulse is applied to both Y and X electrodes while a wall voltage and a sustain pulse is increasingly applied in the selected cells.

Meanwhile, an intensity of the light generated by a phosphor layer of the plasma display panel does not increase with an increasing number of the sustain pulses; instead, the phosphor has a luminance saturation property where the phosphor is saturated in a certain luminance point a.

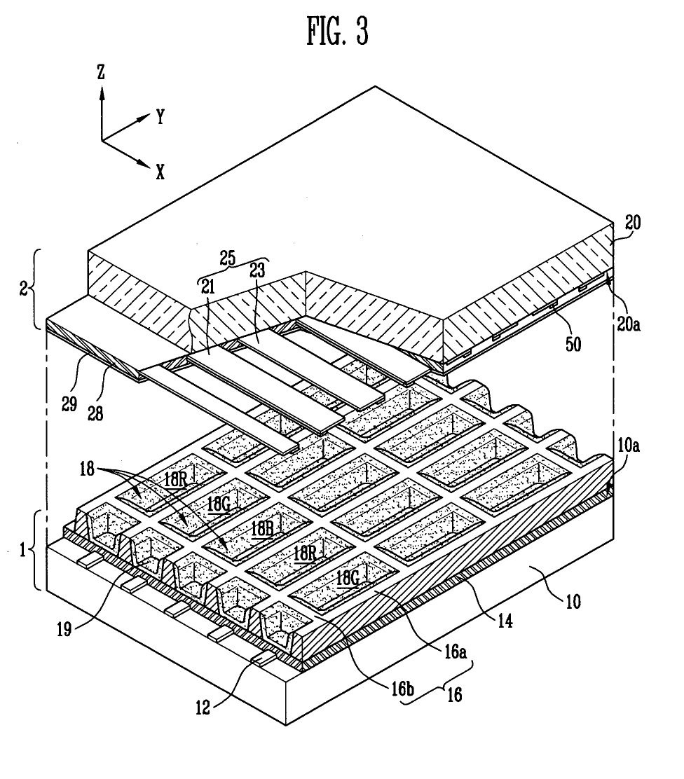

A luminance saturation property is described in detail by referring to FIG. 2. FIG. 2 is a graph showing a luminance saturation rate of the phosphor in the contemporary plasma display panel. For example, assume that a point where luminance of a phosphor is saturated is a point where the number of sustain pulses is 300. Then, the light intensity generated by the corresponding phosphor is as much as the light intensity generated at a point where the number of sustain pulses is 300, even if 500 sustain pulses are applied to the phosphor. This luminance saturation of the phosphor occurs when a sustain pulse is continuously applied to the phosphor.

Considering the cause of luminance saturation property of the phosphor, a phosphor is present in discharge cells under a stable state at an early stage. When the phosphor is relatively unstable after the sustain discharge, the phosphor emits a certain amount of light. Then after a certain time period, the phosphor returns to a stable state.

That is, the phosphor is in an unstable state if a sustain discharge appears, and then returns to the stable state with a passage of a certain time. If a sustain pulse is continuously applied to the phosphor having this physical property, the continuous sustain discharge is generated, and then the phosphor becomes unstable again due to the presence of sustain discharge before the phosphor returns to a stable state. Luminance of the phosphor is saturated by continuously keeping the phosphor unstable due to the repeated presence of sustain discharge.

As a result, a luminance of the plasma display panel is lowered and the driving efficiency of the plasma display panel is reduced since the increase in sustain pulse does not lead to the increase in the light intensity resulted from the luminance saturation properties of the phosphor. In addition, the luminance saturation properties of the phosphor is related to a problem regarding the increase of discharge firing voltage in the high-resolution plasma display panel, and therefore there have been attempts to solve the above problems.

FIG. 3 is an oblique view showing a plasma display panel constructed as an embodiment according to the principles of the present invention.

First, a front panel 2 will be described in detail. Front panel 2 includes a front substrate 20, a sustain electrode 25, a first dielectric layer 28, and a protective layer 29.

Front substrate 20 faces a rear substrate 10 and front substrate 20 is arranged spaced apart at a certain distance from rear substrate 10. Discharge cells 18 (18R, 18G, 18B) having colors are provided in a space between both of rear substrate 10 and front substrate 20, and are formed by barrier ribs 16, 16a, 16b. And, a phosphor layer 19 is formed in discharge cell 18 along the sidewall and the bottom surface of barrier ribs 16. Phosphor layer 19 may be excited by the ultraviolet rays to emit the visible light, and discharge gases (for example, a mixed gas including xenon (Xe), neon (Ne), etc.) may fill the discharge space formed between rear substrate 10 and front substrate 20 to cause a plasma discharge. Front substrate 20 is made from transparent materials, such as glass that can transmit the visible light, in order to display an image.

And, sustain electrodes 25 are formed on a first surface 20a of front substrate 20 facing rear substrate 10 so that sustain electrodes 25 correspond to discharge cells 18 along one direction (x-axis direction in the drawing), respectively. Sustain electrodes 25 are composed of a Y electrode 21 and an X electrode 23. Y electrode 21 selects a discharge cell 18 that is turned on by a reaction with address electrode 12, and X electrode 23 induces a sustain discharge for discharge cell 18 selected by the reaction between Y electrode 21 and address electrode 12. A bus electrode 50 for preventing a voltage drop of sustain electrodes 25 extending along the x axis is provided.

Sustain electrodes 25 are covered and buried by first dielectric layer 28 made from dielectrics such as PbO, B₂O₃, SiO₂, etc. At this time, first dielectric layer 28 functions to prevent charged particles from colliding with sustain electrodes 25 to damage sustain electrodes 25 during the discharge process, and to induce the charged particles.

Meanwhile, a high-resolution plasma display has a problem that the discharge firing voltage increases due to the small size of a fine pitch cell in the high-resolution plasma display. In order to solve the above problem, a discharge voltage is set to a low discharge voltage level by reducing a thickness of first dielectric layer 28. The thickness of first dielectric layer 28 is, however, closely related to the capacity of vacuum ultraviolet rays (VUV) generated from the discharge gases. As a result, it has been experimentally found that, if the thickness of first dielectric layer 28 is thin, then a discharge firing voltage is low, and a lot of vacuum ultraviolet rays are generated.

Accordingly, if first dielectric layer 28 is manufactured with a thin thickness, a lot of vacuum ultraviolet rays are generated to deteriorate the luminance saturation property of the phosphor.

Then, the discharge firing voltage preferably ranges from approximately 250 V to approximately 270 V. One of the important technical problems is to improve luminance saturation properties while meeting this discharge firing voltage. A suitable thickness range of the first dielectric layer has been found to solve the above problems.

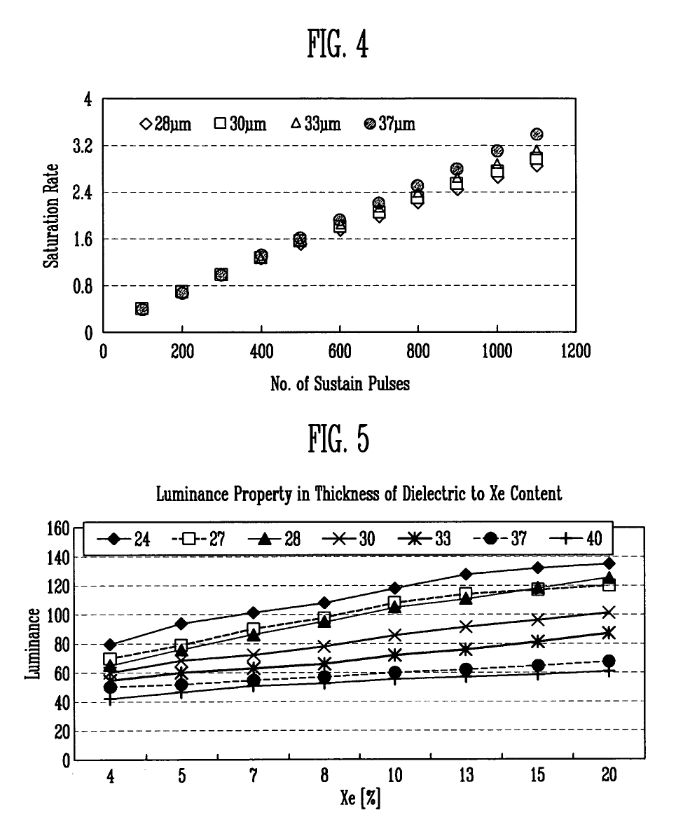

FIG. 4 is a graph illustrating luminance saturation property of a phosphor corresponding to different thickness of a dielectric layer according to one embodiment of the present invention. A horizontal axis represents a sustain pulse number, and a vertical axis represents a saturation rate. In each embodiment, thickness of the first dielectric layer is set to 28 μm, 30 μm, 33 μm and 37 μm. As a result, the first dielectric layer having each of the thickness 28 μm, 30 μm, 33 μm and 37 μm shows a good saturation rate within the discharge firing voltage ranges.

Meanwhile, first dielectric layers are formed with a thickness of 24 μm, 27 μm, 38 μm and 40 μm for comparative examples out of the thickness range of the first dielectric layer. The saturation property of the phosphor was markedly deteriorated in the comparative examples (27 μm, 24 μm) out of the thickness range of the first dielectric layer of less than 28 μm, and dielectric breakdown occurred, as seen in the following Table 1. Also, in comparative examples (38 μm, 40 μm) out of the discharge firing voltage ranges of greater than 37 μm, a discharge firing voltage is too high to meet the requirement of the discharge firing voltage, and it is difficult to drive the plasma display panel.

TABLE 1

| | | | | | | | |
|---|---|---|---|---|---|---|---|
| Thickness of Dielectric | 24 | 27 | 28 | 30 | 33 | 37 | 40 |
| Layer [μm] | | | | | | | |
| Discharge Firing | 234 | 240 | 253 | 260 | 265 | 270 | 285 |
| Voltage [V] | | | | | | | |
| Dielectric | Dielectric | Dielectric | Stable | Stable | Stable | Stable | Stable |
| Breakdown | Breakdown | Breakdown | | | | | |

Accordingly, first dielectric layer 28 is preferably formed at a thickness range of approximately 28 μm to approximately 37 μm. And a thickness range of approximately 30 to approximately 37 μm may be proposed as a preferred thickness range to meet the discharge firing voltage and the luminance saturation property.

And, a lower surface of first dielectric layer 28 may be covered by protective layer 29 made from MgO, etc. Protective layer 29 functions to prevent charged particles from directly colliding with first dielectric layer 28 to damage first dielectric layer 28 during the discharge process, and to enhance a discharge efficiency by releasing secondary electrons when the charged particles collide with first dielectric layer 28.

Next, rear panel 1 is constructed with rear substrate 10, address electrode 12 and a second dielectric layer 14. Address electrode 12 is disposed on an upper surface 10a of rear substrate 10 facing front substrate 20 to correspond to each of discharge cells 18, while address electrode 12 is extending along a direction crossing sustain electrode 25 (y axis direction in the drawing) and spaced apart from each other. Address electrodes 12 are covered and buried by second dielectric layer 14.

Barrier ribs 16 are formed on second dielectric layer 14 with a certain pattern. Barrier rib 16 divides discharge cells 18 which is a discharge space in which a discharge is induces, thereby to prevent a cross talk between the adjacent discharge cells 18. Barrier rib 16 includes vertical barrier ribs 16a spaced apart from each other, and horizontal barrier ribs 16b spaced apart from each other in a direction crossing vertical barrier ribs 16a on the same plane with vertical barrier ribs 16a, as shown in FIG. 4. Therefore, barrier ribs 16 define discharge cells 18 having a closed configuration.

In this embodiment, a configuration of the barrier rib is described in detail as an exemplary embodiment, but it is understood that various configuration of the barrier rib are possible. For example, striped barrier ribs may be formed in a direction parallel to address electrode 12 while the barrier ribs are arranged between address electrodes 12.

And, the inner parts of discharge cells 18 are excited by the ultraviolet rays generated by the discharge to induce phosphor layer 19 to emit the visible light. Phosphor layer 19 is formed on side walls of barrier ribs 16, and a lower surface of second dielectric layer 14 that is defined by barrier ribs 16, as shown in FIG. 4.

Phosphor layer 19 may be selectively made from any one of the red, green and blue phosphors so as to display colors, and therefore may be divided into red, green and blue phosphor layers 18R, 18G, 18B.

As described above, the inner parts of discharge cells 18 having a phosphor layer 19 disposed therein are filled with a mixed discharge gas such as neon (Ne), xenon (Xe), etc. At this time, xenon (Xe) in the discharge gases preferably has a partial pressure of approximately 8 to approximately 15%, in consideration of the thickness of first dielectric layer 28.

FIG. 5 is a graph illustrating a luminance property of a dielectric layer having various thickness, versus the Xe content. As shown in FIG. 5, the luminance property of the dielectric layer is improved in the various thickness of the dielectric layer according to the Xe content, but the dielectric layer exhibits a saturation property similar to the phosphor saturation property with the increasing Xe content if the thickness of the first dielectric layer is less than 28 μm. Also, a luminance of the first dielectric layer increases with the increasing Xe content, but the increased luminance is very low if the thickness of the first dielectric layer exceeds 37 μm. Accordingly, xenon (Xe) preferably has a partial pressure of approximately 8% to approximately 15%.

Meanwhile, in the case of driving a plasma display panel constructed with sustain electrode 25 buried by first dielectric 28, and address electrode 12 buried by second dielectric layer 14 having a thickness of 28 to 37 μm, a frequency of the sustain pulse applied to sustain electrode 25 preferably ranges from approximately 200 KHz to approximately 300 KHz. The second dielectric layer has a low luminance value if the sustain pulse frequency of sustain electrode 25 is less than 200 kHz, whereas the luminance saturation property of the second dielectric layer may be deteriorated if the sustain pulse frequency of sustain electrode 25 exceeds 300 kHz.

The plasma display panel according to the present invention has effects to improve luminance saturation properties while meeting discharge firing voltage in driving the plasma display panel by defining a thickness of the first dielectric layer to a certain thickness range.

Although exemplary embodiments of the present invention have been shown and described, it would be appreciated by those skilled in the art that changes might be made in these embodiments without departing from the principles and spirit of the invention, the scope of which is defined in the claims and their equivalents.

For example, a three-electrode surface discharge structure has been described in detail in the above embodiments, but other surface discharge structure may also be applied to the present invention by those skilled in the art.

What is claimed is:

1. A plasma display panel, comprising:
a front panel, comprising:
a front substrate
a sustain electrode formed on the front substrate; and
a dielectric layer burying the sustain electrode;
a rear panel comprising an address electrode extending in a direction crossing the sustain electrode; and
a discharge space formed between the front panel and the rear panel, with the dielectric layer having a thickness of approximately 28 μm to approximately 37 μm.

2. The plasma display panel according to claim 1, comprised of the dielectric layer having a thickness of approximately 30 μm to approximately 37 μm.

3. The plasma display panel according to claim 1, comprised of the dielectric layer being made from one selected from the group consisting essentially of PbO, B₂O₃, and SiO₂.

4. The plasma display panel according to claim 1, further comprising discharge gases filled in the discharge space, with the discharge gases comprising Xe.

5. The plasma display panel according to claim 4, comprised of the Xe in the discharge gases having a partial pressure of approximately 8 to approximately 15%.

6. A plasma display panel, comprising:
a front panel, comprising:
a front substrate;
a sustain electrode formed on a first surface of the front substrate;
a first dielectric layer burying the sustain electrode; and
a protective layer protecting the first dielectric layer;
a rear panel facing the front panel, and comprising:
an address electrode formed on a surface of the rear panel facing the front substrate; and
a second dielectric layer burying the address electrode;
a barrier rib formed between the front panel and the rear panel, and dividing a discharge space containing discharge gases into certain patterns; and
a phosphor layer provided inside the discharge space, with the first dielectric layer having a thickness of approximately 28 μm to approximately 37 μm.

7. The plasma display panel according to claim 6, comprised of the sustain electrode comprising:
a Y electrode for selecting a discharge cell with the address electrode; and
an X electrode for generating a sustain discharge in the selected discharge cell with the Y electrode.

8. The plasma display panel according to claim 7, comprised of the first dielectric layer having a thickness of approximately 30 μm to approximately 37 μm.

9. The plasma display panel according to claim 7, comprised of the dielectric layer being made from one selected from the group consisting essentially of PbO, B₂O₃, and SiO₂.

10. The plasma display panel according to claim 7, comprised of the discharge gases presented in the discharge space comprising Xe.

11. The plasma display panel according to claim 10, comprised of the Xe in the discharge gases having a partial pressure of approximately 8% to approximately 15%.

12. A method for driving a plasma display panel, comprising:
applying a sustain pulse to a sustain electrode formed inside the plasma display panel, with the plasma display panel comprising:
a first dielectric layer burying the sustain electrode; and
an address electrode buried by a second dielectric layer, with the first dielectric layer having a thickness of 28 to 37 μm,
with the frequency of the sustain pulse ranging from approximately 200 KHz to approximately 300 KHz.
